(19) United States
(12) Patent Application Publication
(10) Pub. No.: US 2012/0023703 A1
(43) Pub. Date: Feb. 2, 2012

(54) HINGE ASSEMBLY FOR FOLDABLE ELECTRONIC DEVICE

(75) Inventors: CHAO DUAN, Shenzhen City (CN); CHIA-HUA CHEN, Shindian (TW)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/871,950

(22) Filed: Aug. 31, 2010

(30) Foreign Application Priority Data
Jul. 30, 2010 (CN) 201010241380.X

(51) Int. Cl. E05D 11/00; E05F 1/08

(52) U.S. Cl. 16/250

(57) ABSTRACT

An exemplary hinge assembly includes a sleeve, a first member, a second member, and a resilient member. The sleeve includes an end wall, a circumferential wall and an open end. A shaft portion is formed on the end wall. The shaft portion extends in the space defined by the circumferential wall and opposite to the open end. The first member is rotatable about the shaft portion. The second member is located next to the first member and rotatable about the shaft portion. The resilient member is placed around the shaft portion and provides an elastic force biasing the first member and the second member into contact with each other. The shaft portion is configured to prevent the first member, the second member and the resilient member from separating from the shaft portion.

### BACKGROUND

1. Technical Field

The present disclosure relates to hinge assemblies and, particularly, to a hinge assembly for foldable electronic devices such as mobile phones, portable computers, and so on.

2. Description of Related Art

At present, perhaps the most popular portable electronic device in the marketplace is the foldable mobile phone, which generally includes a cover section and a body section. The cover section and the body section are rotatably interconnected through a hinge assembly, for switching the telephone between an open position and a closed position.

However, traditional hinge assemblies include a large number of mechanical elements. Thus, the assembly process can be relatively complicated.

Therefore, there is room for improvement within the art.

### BRIEF DESCRIPTION OF THE DRAWINGS

Many aspects of the present hinge assembly can be better understood with reference to the following drawings. The components in the drawings are not necessarily drawn to scale, the emphasis instead being placed upon clearly illustrating the principles of the present hinge assembly. Moreover, in the drawings, like reference numerals designate corresponding parts throughout the several views.

FIG. 1 is an exploded, isometric view of a hinge assembly.

FIG. 2 is similar to FIG. 1, but shown from another aspect.

FIG. 3 is an assembled view of the hinge assembly shown in FIG. 1.

FIG. 4 is a cross sectional view of the sleeve in FIG. 1.

FIG. 5 is a cross sectional view of FIG. 3 taken along line V-V.

FIG. 6 is a cross sectional view after one end of the shaft portion is deformed.

### DETAILED DESCRIPTION

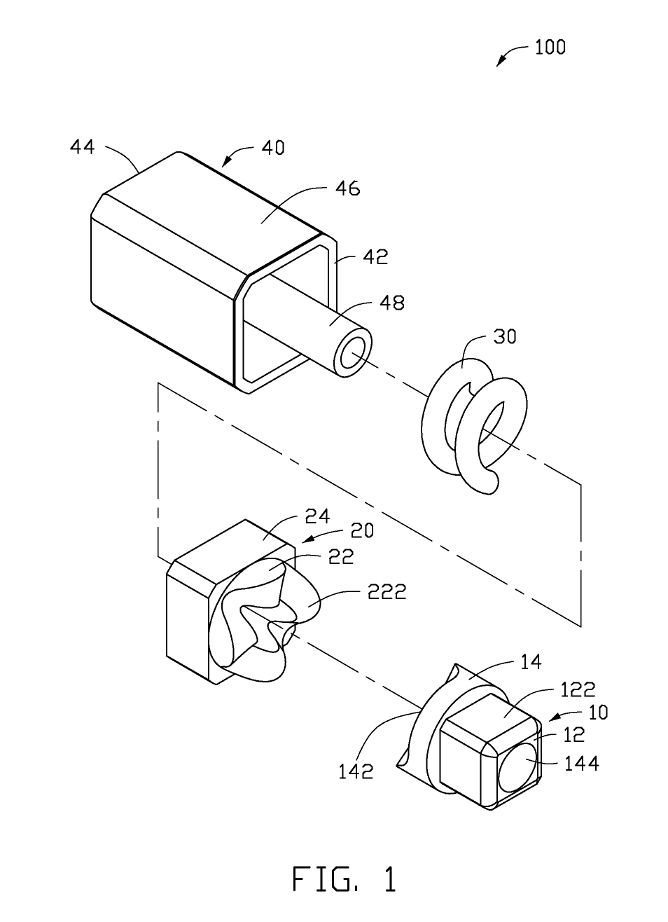

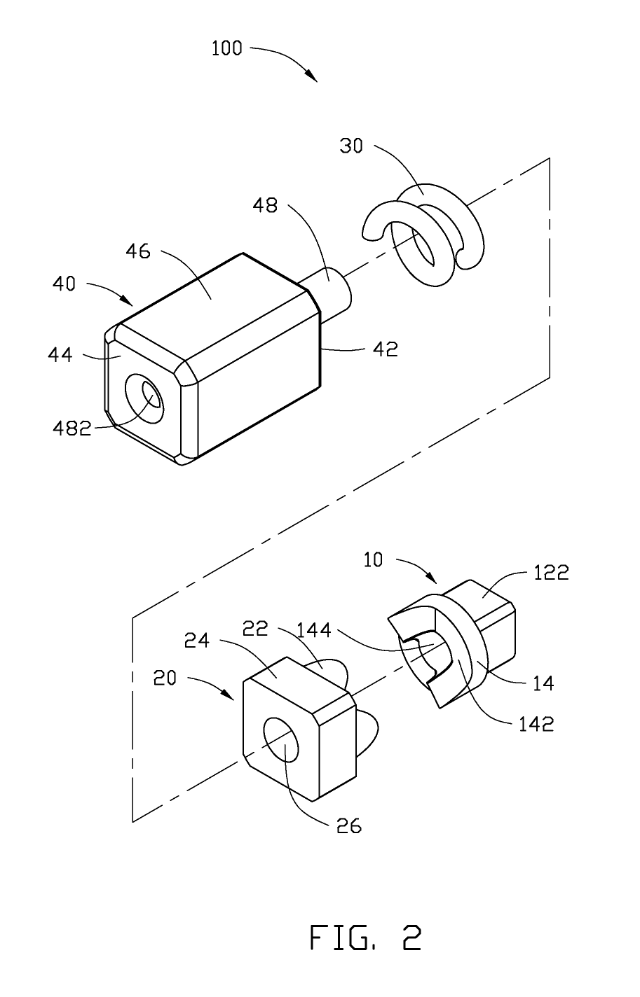

FIGS. 1 and 2 show a hinge assembly 100 according to an exemplary embodiment of the present hinge system. The hinge assembly 100 includes a first member 10, a second member 20, a resilient member 30, and a sleeve 40. The first member 10, the second member 20 and the resilient member 30 are accommodated in the sleeve 40.

The first member 10 coaxially includes a head portion 12 and a cam portion 14 integrally formed together. The head portion 12 is for engaging with a body section of a foldable electronic device. In an exemplary embodiment, the head portion 12 is substantially cubic, including a plurality of planar surfaces 122. The cam portion 14 is formed at one side of the head portion 12, and has a larger radius size than the head portion 12. The cam portion 14 includes at least one, e.g. two symmetrically arranged first cam surfaces 142. Each first cam surface 142 includes at least one peak and at least one valley. The first member 10 defines a through hole 144 communicating with the head portion 12 and the cam portion 14.

The second member 20 includes a latching cam portion 22 and an end portion 24 extending from the latching cam portion 22. A longitudinal passage 26 is defined in the second member 20. The latching cam portion 22 includes a second cam surface 222 for engaging with the first cam surfaces 142 of the first member 10. There is one second cam surface 222 for each first cam surface 142. The end portion 22 is substantially cubic for non-rotatably engaging with the sleeve 40.

The resilient member 30 can be spiral-shaped (e.g. a coil spring). The resilient member 30 exerts elastic force on the second member 20 to push the second member 20 toward the first member 10.

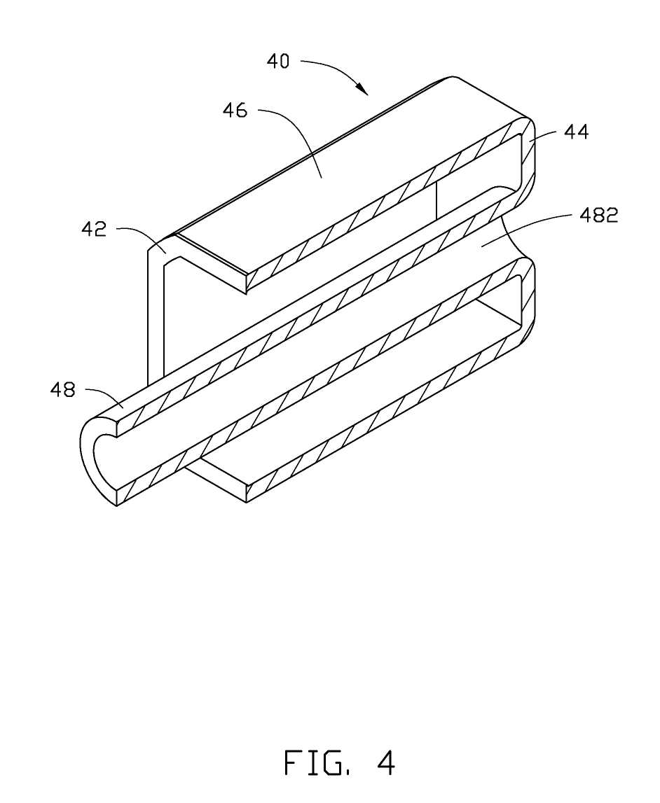

Referring to FIG. 4, the sleeve 40 is substantially a hollow polygonal cylinder. In an exemplary embodiment, the sleeve 40 is cubic and is for being non-rotatably connected to a cover section of a foldable electronic device. The sleeve 40 includes an open end 42, an end wall 44, and a circumferential wall 46. The end wall 44 is positioned at one end of the circumferential wall 46 and is opposite to the open end 42. A shaft portion 48 is formed on a center of the end wall 44 and is received in the space defined by the circumferential wall 46. The shaft 48 may extend to outside of the sleeve 40. The resilient member 30 has an inside diameter which is large enough to allow it to be placed around the shaft portion 48. The shaft portion 48 is integrally formed with the sleeve 40 using a punch press process. In an exemplary embodiment, the end wall 44 is curved and extends into the sleeve 40 to form a hollow shaft portion 48. A shaft hole 482 is defined in the shaft portion 48.

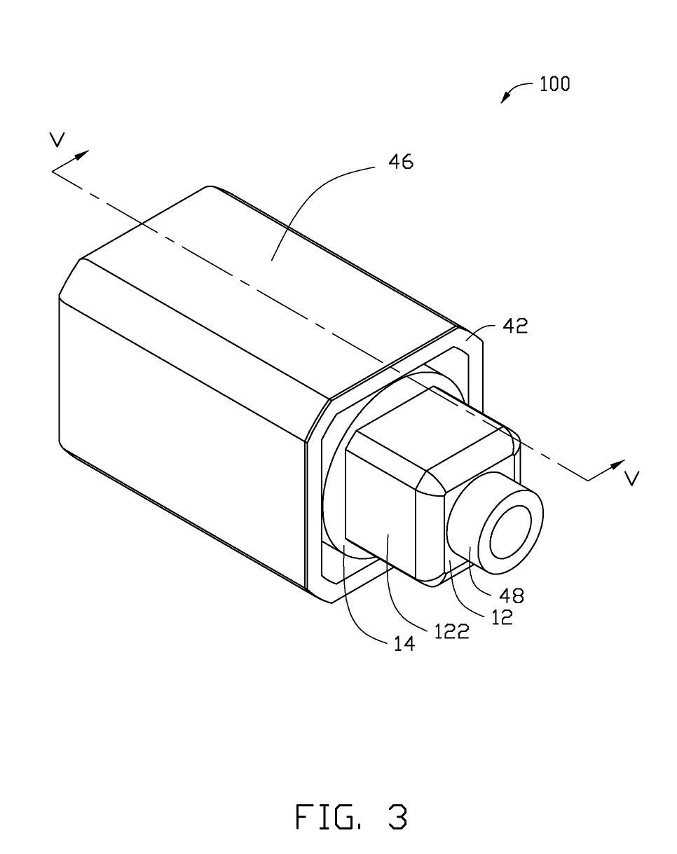

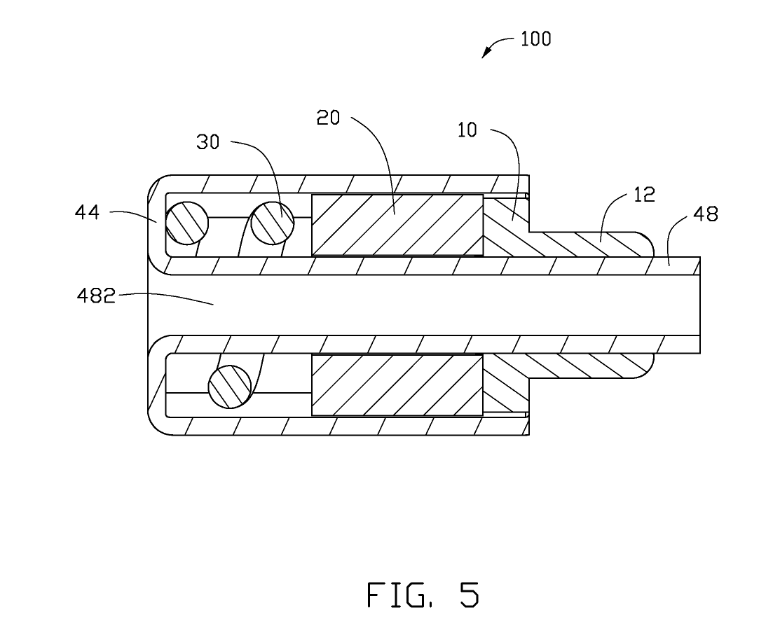

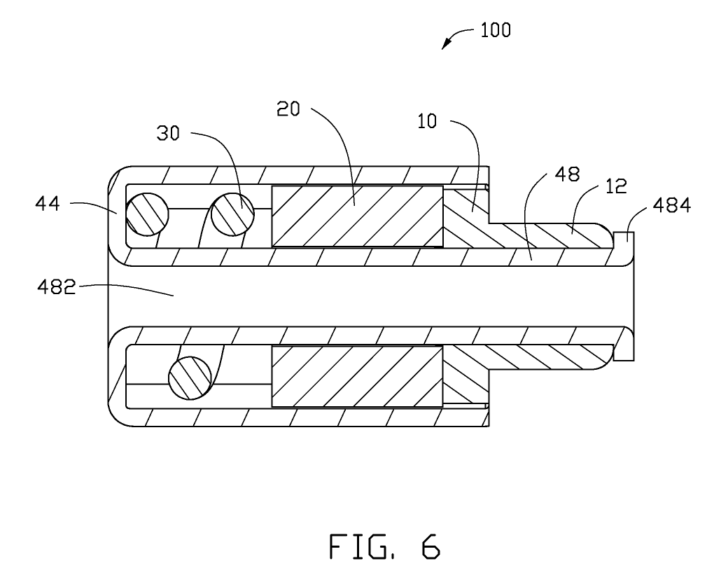

Referring to FIG. 3 and FIG. 5, the resilient member 30, the second member 20 and the first member 10 are orderly fit over the shaft portion 48, and are received in the sleeve 40. The second cam surface 222 of the second member 20 engages with the first cam surface 142 of the first member 10. One end of the resilient member 30 abuts against the end wall 44, and the opposite end of the resilient member 30 abuts against the second member 20. The head portion 12 is exposed from the sleeve 40. Referring to FIG. 6, by configuration of the end of shaft portion 48, the first member 10 is rotatably positioned on the shaft portion 48, and kept from detaching or separating from the shaft portion 48. For example, one end of the shaft portion 48 is deformed to form a latching end 484 to prevent the first member 10 from separating from the shaft portion 48. Alternatively, one end of the shaft portion 48 may be manufactured to have a plurality of protrusions by a press punch process. The protrusions can prevent the above elements in the shaft portion 48 from separating from the shaft portion 48. Accordingly, the hinge assembly 100 is integrated into a complete unit.

It should be understood that the cam portions of the first member 10 and the second member 20 may have other shapes. The shape of the cam portion may be changed according to the desired open angle of the cover. The shaft 48 does not extend to outside of the sleeve 40, but is completely received in the sleeve 40.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A sleeve for a hinge assembly, the sleeve comprising an end wall, a circumferential wall and an open end, a shaft portion being formed on the end wall, the shaft portion extending in the space defined by the circumferential wall and opposite to the open end.

2. The sleeve as claimed in claim 1, wherein the shaft portion defines a shaft hole, and a portion of the end wall is curved and extends through the sleeve to form the shaft portion.

3. The sleeve as claimed in claim 1, wherein the shaft portion extends to outside of the sleeve.

4. A hinge assembly comprising:
a sleeve comprising an end wall, a circumferential wall and an open end, the end wall forming a shaft portion, the shaft portion extending in the space defined by the circumferential wall and opposite to the open end;
a first member rotatable about the shaft portion;
a second member located next to the first member and rotatable about the shaft portion;
a resilient member being fitted over the shaft portion and providing an elastic force to bias the first member and the second member into contact with each other;
wherein the shaft portion is configured to prevent the first member, the second member and the resilient member from separating from the shaft portion.

5. The hinge assembly as claimed in claim 4, wherein the shaft portion defines a shaft hole, and the shaft portion is formed by drawing a portion of the end wall through the sleeve.

6. The hinge assembly as claimed in claim 5, wherein the shaft portion extends to outside of the sleeve.

7. The hinge assembly as claimed in claim 5, wherein the shaft portion is integrally formed with the sleeve with a punch press process.

8. The hinge assembly as claimed in claim 7, wherein a portion of the end wall is drawn through an inside of the sleeve to form a hollow shaft portion.

9. A hinge assembly comprising:
a sleeve including a shaft portion integrally formed with the sleeve;
a first member rotatable about the shaft portion;
a second member located next to the first member and rotatable about the shaft portion;
a resilient member being fitted over the shaft portion and providing an elastic force to bias the first member and the second member into contact with each other;
wherein a latching end is formed on the shaft portion to prevent the first member, the second member and the resilient member from separating from the shaft portion.

10. The hinge assembly as claimed in claim 9, wherein the sleeve includes an end wall, a circumferential wall and an open end, the shaft portion is formed on the end wall, and extends in the space defined by the circumferential wall and opposite to the open end.

11. The hinge assembly as claimed in claim 10, wherein the shaft portion defines a shaft hole, and the shaft portion is formed by drawing a portion of the end wall through the sleeve.
